(19) United States
(12) Patent Application Publication
(10) Pub. No.: US 2008/0162472 A1
(43) Pub. Date: Jul. 3, 2008

(54) METHOD AND APPARATUS FOR VOICE SEARCHING IN A MOBILE COMMUNICATION DEVICE

(75) Inventors: Yan Ming Cheng, Inverness, IL (US); Changxue C. Ma, Barrington, IL (US); Theodore Mazurkiewicz, Lake Zurich, IL (US); Paul C. Davis, Chicago, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/617,134

(22) Filed: Dec. 28, 2006

(51) Int. Cl. G06F 17/30; G06F 3/048

(52) U.S. Cl. 707/6; 715/835; 707/E17.014

(57) ABSTRACT

A method and apparatus for performing a voice search in a mobile communication device is disclosed. The method may include receiving a search query from a user of the mobile communication device, converting speech parts in the search query into linguistic representations, comparing the query linguistic representations to the linguistic representations of all items in the voice search database to find matches, wherein the voice search database has indexed all items that are associated with the device, displaying the matches to the user, receiving the user's selection from the displayed matches, and retrieving and executing the user's selection.

### BACKGROUND OF THE INVENTION

1. Field of the Invention

The invention relates to mobile communication devices.

2. Introduction

Mobile communication devices are getting more and more “smart” by offering a wide variety of features and functions. Furthermore, these features and functions require the storage of more and more content, such as music and photos, and all kinds of events, such as call history, web favorites, web visits, etc. However, conventional mobile devices offer very limited ways to reach the features, functions, content, events, applications, etc. that they enable. Currently, mobile devices offer browsing and dialogue through a hierarchical tree structure to reach or access these features, functions, content, events, and applications. However, this type of accessing technology is very rigid, hard to remember and very tedious for feature rich devices. Thus, conventional mobile devices lack an intuitive, friendly and casual way for the accessing technology

### SUMMARY OF THE INVENTION

A method and apparatus for performing a voice search in a mobile communication device is disclosed. The method may include receiving a search query from a user of the mobile communication device, converting speech parts in the search query into linguistic representations, comparing the query linguistic representations to the linguistic representations of all items in the voice search database to find matches, wherein the voice search database has indexed all items that are associated with the device, displaying the matches to the user, receiving the user's selection from the displayed matches, and retrieving and executing the user's selection.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a mobile communication device in accordance with a possible embodiment of the invention;

FIG. 2 illustrates a block diagram of an exemplary mobile communication device in accordance with a possible embodiment of the invention; and

FIG. 3 is an exemplary flowchart illustrating one possible voice search process in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The invention comprises a variety of embodiments, such as a method and apparatus and other embodiments that relate to the basic concepts of the invention.

This invention concerns a manner in which all features, functions, files, content, events, etc. of all applications on a device and on external devices, may be indexed and searched in response to a user's voice query.

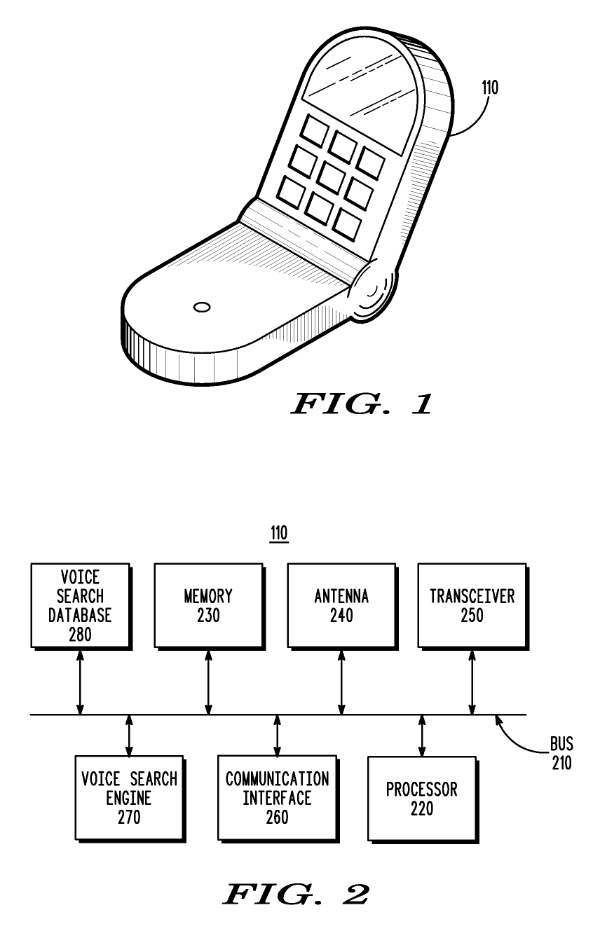

FIG. 1 illustrates an exemplary diagram of a mobile communication device 110 in accordance with a possible embodiment of the invention. While FIG. 1 shows the mobile communication device 110 as a wireless telephone, the mobile communication device 110 may represent any mobile or portable device, including a mobile telephone, cellular telephone, a wireless radio, a portable computer, a laptop, an MP3 player, satellite radio, satellite television, Digital Video Recorder (DVR), television set-top box, etc.

FIG. 2 illustrates a block diagram of an exemplary mobile communication device 110 having a voice search engine 270 in accordance with a possible embodiment of the invention. The exemplary mobile communication device 110 may include a bus 210, a processor 220, a memory 230, an antenna 240, a transceiver 250, a communication interface 260, voice search engine 270, and voice search database 280. Bus 210 may permit communication among the components of the mobile communication device 110.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Transceiver 250 may include one or more transmitters and receivers. The transceiver 250 may include sufficient functionality to interface with any network or communication station and may be defined by hardware or software in any manner known to one of skill in the art. The processor 220 is cooperatively operable with the transceiver 250 to support operations within the communication network.

Communication interface 260 may include any mechanism that facilitates communication via the communication network. For example, communication interface 260 may include a modem. Alternatively, communication interface 260 may include other mechanisms for assisting the transceiver 250 in communicating with other devices and/or systems via wireless connections.

The mobile communication device 110 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 260.

The voice search database 280 indexes all features, functions, files, content, events, applications, etc. in the mobile communication device 110 and stores them as items with indices. Each item in the voice search database 280 has linguistic representations for identification and matching purpose. The linguistic representations hereafter may include phoneme representation, syllabic representation, morpheme representation, word representation, etc. for comparison and matching purposes. Theses representations are distinguished from the textual description, which is for reading purposes.

As features, functions, files, content, events, applications, etc. are added to the mobile communication device 110, they may be originally described by text, speech, pictures, etc., for example. If original description is text, the text is translated to the linguistic representation; and if the original description is speech or picture, their text metadata is translated to the linguistic representations. If the metadata is not available, it may be obtained from the user or inferred from the content by comparison with similar content on the device or external to the device, and then translated to a linguistic representation.

The voice search database 280 may also contain a categorized index of each item stored. The categorized indices stored on the voice search database 280 are organized in such a manner that they can be easily navigated and displayed on the mobile communication device 110. For example, all of the indices of a single category can be displayed or summarized within one display tab, which can be brought to foreground of the display or can be hidden by a single click; and an index within a category can be selected by a single click and launched with a default application associated with the category. These user selectable actions can also be completed through voice commands.

The voice search database 280 may also contain features, functions, files, content, events, applications, etc. stored on other devices. For example, a user may have information stored on a laptop computer or another mobile communication device which may be indexed and categorized in the voice search database 280. The user may request these features, functions, files, content, events, applications, etc. which the voice search engine 270 may extract from the other devices in response to the user's query. Note also, that while voice search database 280 is shown as a separate entity in the diagram, the voice search database 280 may be stored in memory 230, or externally in another computer-readable medium.

The mobile communication device 110 illustrated in FIGS. 1 and 2 and the related discussion are intended to provide a brief, general description of a suitable communication and processing environment in which the invention may be implemented. Although not required, the invention will be described, at least in part, in the general context of computer-executable instructions, such as program modules, being executed by the mobile communication device 110, such as a communication server, or general purpose computer. Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including cellular devices, mobile communication devices, personal computers, hand-held devices, multi-processor systems, microprocessor-based or programmable consumer electronics, and the like.

For illustrative purposes, the operation of the voice search engine 270 and voice search process will be described below in relation to the block diagrams shown in FIGS. 1 and 2.

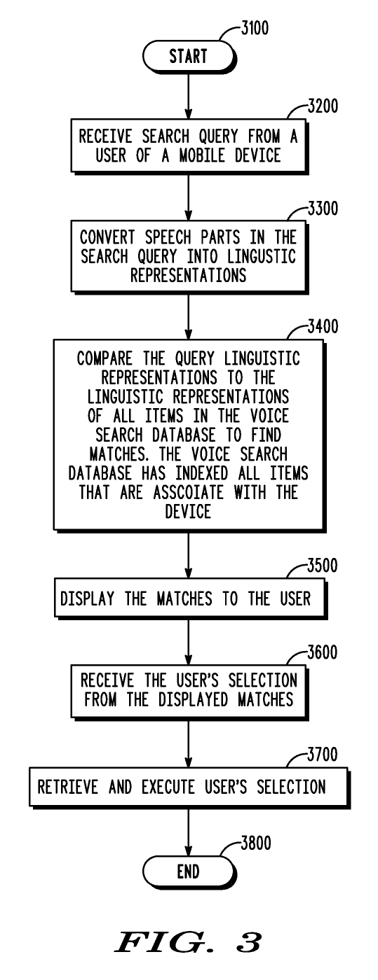

FIG. 3 is an exemplary flowchart illustrating some of the basic steps associated with a voice search process in accordance with a possible embodiment of the invention. The process begins at step 3100 and continues to step 3200 where the voice search engine 270 receives a search query from a user of the mobile communication device 110. For example, the user may request Matthew's picture, Megan's address, or the title to a song at main menu of the voice search user interface. As discussed above, the item requested does not have to reside on the mobile communication device 110. The item may be stored on another device, such as a personal computer, laptop computer, another mobile communication device, MP3 player, etc.

At step 3300, the voice search engine 270 recognizes the speech parts of the search query. For example, the voice search engine 270 may use an automatic speech recognition (ASR) system to convert the voice query into linguistic representations, such as words, morphemes, syllables, phonemes, phones, etc., within the spirit and scope of the invention.

At step 3400, the voice search engine 270 compares the recognized linguistic representations to the linguistic representations of each item stored in the voice search database 280 to find matches. At step 3500, the voice search engine displays the matched items to the user according to their categorized indices. The matches may be displayed as categorized tabs, as a list, as icons, images, or audio files for example.

At step 3600, the voice search engine 270 receives the user selection from the displayed matches. At step 3700, the voice search engine 270 retrieves the features, functions, files, content, events, applications, etc. on the device or devices, which correspond to the user selected items; and then the voice search engine 270 executes the retrieved material to the user according to the material's category. For example, the retrieved material is a media file, the voice search engine 270 will play it to user; if it is a help topic, an email, a photo, etc, and voice search engine 270 will display it to the user. The process goes to step 3800, and ends.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communication connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the voice search engine 270 in FIG. 2 each processing the content in various possible ways. It does not necessarily need to be one system used by all end users. Accordingly, the appended claims and their legal equivalents should only define the invention, rather than any specific examples given.

We claim:

1. A method for performing a voice search in a mobile communication device, comprising:
receiving a search query from a user of the mobile communication device;
converting speech parts in the search query into linguistic representations;
comparing the query linguistic representations to the linguistic representations of all items in the voice search database to find matches, wherein the voice search database has indexed all items that are associated with the mobile communication device;
displaying the matches to the user;
receiving the user's selection from the displayed matches; and
retrieving and executing the user's selection.

2. The method of claim 1, wherein the linguistic representations are at least one of words, morphemes, syllables, phones, and phonemes.

3. The method of claim 1, wherein the items are at least one of features, functions, files, content, events, and applications.

4. The method of claim 1, wherein the items may be associated with a device that is one of internal and external to the mobile communication device.

5. The method of claim 1, wherein the user's selection causes an operation to be performed on the mobile communication device.

6. The method of claim 1, wherein the matches are displayed as at least one of a list, tabs, icons, images, or audio file.

7. The method of claim 1, wherein the mobile communication device is one of a mobile telephone, cellular telephone, a wireless radio, a portable computer, a laptop, an MP3 player, satellite radio, satellite television, Digital Video Recorder (DVR), and television set-top box.

8. An apparatus that performs a voice search in a mobile communication device, comprising:
a voice search database that has indexed all items that are associated with the mobile communication device; and
a voice search engine that receives a search query from a user of the mobile communication device, converts speech parts in the search query into linguistic representations, compares the query linguistic representations to the linguistic representations of all items in the voice search database to find matches, displays the matches to the user, receives the user's selection from the displayed matches, and retrieves and executes the user's selection.

9. The apparatus of claim 8, wherein the linguistic representations are at least one of words, morphemes, syllables, phones, and phonemes.

10. The apparatus of claim 8, wherein the items are at least one of features, functions, files, content, events, applications.

11. The apparatus of claim 8, wherein the items may be associated with a device that is one of internal and external to the mobile communication device.

12. The apparatus of claim 8, wherein the user's selection causes an operation to be performed on the mobile communication device.

13. The apparatus of claim 8, wherein the matches are displayed as at least one of a list, tabs, icons, images, or audio file.

14. The apparatus of claim 8, wherein the mobile communication device is one of a mobile telephone, cellular telephone, a wireless radio, a portable computer, a laptop, an MP3 player, satellite radio, satellite television, Digital Video Recorder (DVR), and television set-top box.

15. A mobile communication device, comprising:
a transceiver that sends and receives signals;
a voice search database that has indexed all items that are associated with the mobile communication device; and
a voice search engine that receives a search query from a user of the mobile communication device, converts speech parts in the search query into linguistic representations, compares the query linguistic representations to the linguistic representations of all items in the voice search database to find matches, displays the matches to the user, receives the user's selection from the displayed matches, and retrieves and executes the user's selection.

16. The mobile communication device of claim 15, wherein the linguistic representations are at least one of words, morphemes, syllables, phones, and phonemes.

17. The mobile communication device of claim 15, wherein the items are at least one of features, functions, files, content, events, and applications.

18. The mobile communication device of claim 15, wherein the items may be associated with a device that is one of external and internal to the mobile communication device.

19. The mobile communication device of claim 15, wherein the user's selection causes an operation to be performed on the mobile communication device.

20. The mobile communication device of claim 15, wherein the mobile communication device is one of a mobile telephone, cellular telephone, a wireless radio, a portable computer, a laptop, an MP3 player, satellite radio, satellite television, Digital Video Recorder (DVR), and television set-top box.
